(19) United States
(12) Patent Application Publication
(10) Pub. No.: US 2026/0087388 A1
(43) Pub. Date: Mar. 26, 2026

(54) GENERALIZED ENTANGLEMENT FORGING WITH SLATER DETERMINANTS

(71) Applicants: International Business Machines Corporation, Armonk, NY (US); The Boeing Company, Arlington, VA (US)

(72) Inventors: Mario Motta, San Jose, CA (US); Ieva Liepuoniute, San Jose, CA (US); Julia Elizabeth Rice, Sunnyvale, CA (US); Tanvi Pradeep Gujarati, San Jose, CA (US); Triet Nguyen Friedhoff, Cincinnati, OH (US); Tyler Benjamin Smith, Saint Petersburg, FL (US); Nam Hoang Nguyen, Anaheim, CA (US); Hiromichi Nishimura, Darien, CT (US); Kristen Smith Williams, Madison, AL (US)

(21) Appl. No.: 18/892,848

(22) Filed: Sep. 23, 2024

(51) Int. Cl. G06N 10/20

(52) U.S. Cl. CPC G06N 10/20

(57) ABSTRACT

Systems and techniques that facilitate generalized entanglement forging (GEF) of an electronic structure are provided. For example, one or more embodiments described herein can comprise a system, which can comprise a memory that can store computer executable components. The system can also comprise a processor, operably coupled to the memory that can execute at least one of the computer executable components that can generalize entanglement forging of an electronic structure for quantum operations, wherein GEF comprises initializing a calculation with a set of classical reference states, wherein the set of classical reference states are non-orthogonal Slater determinants. GEF can further comprise: correlating, on a quantum system, the set of classical reference states using a local unitary cluster Jastrow ansatz, wherein the Jastrow ansatz is initialized from a classical electronic structure calculation; and minimizing an energy function over a set of variational parameters of a wavefunction that represents the electronic structure.

### BACKGROUND

The subject disclosure relates to quantum simulation of electronic structures, and more specifically, to generalized entanglement forging (GEF) with Slater determinants of electronic structures for quantum operations.

Entanglement forging (EF) is a quantum algorithm that leverages entanglement (e.g., where two or more quantum particles become interconnected in such a way that the state of one particle instantly influences the state of the other(s), regardless of the distance between them) and spin symmetries in a quantum system to reduce the number of qubits required by the quantum system in half for simulating the electronic structure of the full system. However, EF has many limitations that can resultingly yield in ineffective and unproductive results in studying quantum systems. Particularly, for simulating electronic structures for applications of chemistry, accuracy of results is crucial. Therefore, EF has limited capabilities for quantum simulation of electronic structures to extract accurate information and results.

The above-described background description is merely intended to provide a contextual overview regarding EF for quantum simulation of electronic structures and is not intended to be exhaustive.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate generalized entanglement forging (GEF) with Slater determinants of electronic structures for quantum operations are provided.

According to an embodiment, a system can comprise a memory that stores computer executable components. The system can further comprise a processor that executes at least one of the computer executable components that can generalize entanglement forging of an electronic structure for quantum operations, wherein generalized entanglement forging (GEF) comprises: initializing a calculation with a set of classical reference states, wherein the set of classical reference states are non-orthogonal Slater determinants; correlating, on a quantum system, the set of classical reference states using a Jastrow ansatz, wherein the Jastrow ansatz is initialized from a classical electronic structure calculation; and minimizing an energy function over a set of variational parameters of a wavefunction that represents the electronic structure.

According to another embodiment, a computer-implemented method can comprise generalizing, by a system operatively coupled to a processor, entanglement forging of an electronic structure for quantum operations, wherein generalized entanglement forging (GEF) comprises: initializing a calculation with a set of classical reference states, wherein the set of classical reference states are non-orthogonal Slater determinants; correlating, on a quantum system, the set of classical reference states using a Jastrow ansatz, wherein the Jastrow ansatz is initialized from a classical electronic structure calculation; and minimizing an energy function over a set of variational parameters of a wavefunction that represents the electronic structure.

According to another embodiment, a computer program product for generalized entanglement forging of electronic structures for quantum operations comprising a computer readable storage medium having program instructions embodied therewith, the program instructions executable by a processor to cause the processor to generalize entanglement forging of an electronic structure for quantum operations, wherein generalized entanglement forging (GEF) comprises: initializing a calculation with a set of classical reference states, wherein the set of classical reference states are non-orthogonal Slater determinants; correlating, on a quantum system, the set of classical reference states using a Jastrow ansatz, wherein the Jastrow ansatz is initialized from a classical electronic structure calculation; and minimizing an energy function over a set of variational parameters of a wavefunction that represents the electronic structure.

### DESCRIPTION OF THE DRAWINGS

FIG. 1 illustrates a block diagram of example, non-limiting system that can facilitate generalized entanglement forging with Slater determinants of an electronic structure for quantum operations in accordance with one or more embodiments described herein.

FIG. 2 illustrates an example, non-limiting block diagram including Slater determinants that can facilitate generalized entanglement forging with Slater determinants of an electronic structure for quantum operations in accordance with one or more embodiments described herein.

FIG. 3 illustrates a block diagram of an example, non-limiting quantum system that can at least partially facilitate generalized entanglement forging with Slater determinants of an electronic structure for quantum operations in accordance with one or more embodiments described herein.

FIG. 4 illustrates a diagram of an example, non-limiting quantum circuit that can prepare superpositions of Slater determinants in accordance with one or more embodiments described herein.

FIGS. 5A and 5B illustrate a diagram of an example, non-limiting quantum circuit that can facilitate generalized entanglement forging with Slater determinants in accordance with one or more embodiments described herein.

FIG. 6 illustrates a diagram of an example, non-limiting quantum circuit that can facilitate generalized entanglement forging with Slater determinants in accordance with one or more embodiments described herein.

FIG. 7 illustrates an example, non-limiting diagram showing a workflow of entanglement forging with Slater determinants in accordance with one or more embodiments described herein.

FIGS. 8-10 an example, non-limiting diagram showing performance results of generalized entanglement forging with Slater determinants of an electronic structure for quantum operations in accordance with one or more embodiments described herein.

FIG. 11 illustrates a flow diagram of an example, non-limiting method that can facilitate generalized entanglement forging with Slater determinants of an electronic structure for quantum operations in accordance with one or more embodiments described herein.

FIG. 12 illustrates a flow diagram of an example, non-limiting method that can facilitate generalized entanglement forging with Slater determinants of an electronic structure for quantum operations in accordance with one or more embodiments described herein.

FIG. 13 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

According to an embodiment, a system can comprise a memory that stores computer executable components. The system can further comprise a processor that executes at least one of the computer executable components that can generalize entanglement forging (EF) of an electronic structure for quantum operations, wherein generalized entanglement forging (GEF) comprises: initializing a calculation with a set of classical reference states, wherein the set of classical reference states are non-orthogonal Slater determinants; correlating, on a quantum system, the set of classical reference states using a Jastrow ansatz, wherein the Jastrow ansatz is initialized from a classical electronic structure calculation; and minimizing an energy function over a set of variational parameters of a wavefunction that represents the electronic structure. Such embodiments of the system can provide a number of advantages, including improving processing efficiency of EF, improving accuracy of EF, and reducing computation costs of EF to evaluate an energy of the electronic structure.

In one or more embodiments of the aforementioned system, wherein initializing the calculation with the set of classical reference states comprises replacing bitstrings in EF with the non-orthogonal Slater determinants to represent quantum states of the electronic structure. Such embodiments of the system can provide a number of advantages, including improving accuracy of EF by improving description of the wavefunction of the system.

In one or more embodiments of the aforementioned system, at least one of the computer executable components can further: decompose a Hamiltonian that represents the electronic structure using a low-rank decomposition; and partition the Hamiltonian into subsystems. Such embodiments of the system can provide a number of advantages, including reducing computation costs of EF to evaluate an energy of the electronic structure without increasing quantum circuit depth, and improving scalability of EF.

In one or more embodiments of the aforementioned system, partitioning the Hamiltonian into subsystems can comprise partitioning the Hamiltonian into operators acting on halves of the electronic structure, wherein the operators are measured over a GEF quantum circuit. Such embodiments of the system can provide a number of advantages, including improving scalability of EF and reducing computation costs of EF to evaluate an energy of the electronic structure.

In one or more embodiments of the aforementioned system, at least one of the computer executable components can further prepare diagonal states and superposition states of the non-orthogonal Slater determinants with a quantum circuit to evaluate the energy function. Such embodiments of the system can provide a number of advantages, including improving processing efficiency of EF and improving accuracy of EF.

In one or more embodiments of the aforementioned system, decomposing the Hamiltonian can comprise: diagonalizing and partitioning terms of the Hamiltonian to construct the subsystems of the electronic structure; obtaining measurements of qubits that represent quantum states of the subsystems over the GEF quantum circuit; and combining the measurements of the subsystems to determine an energy of the electronic structure. Such embodiments of the system can provide a number of advantages, including, improving processing efficiency of EF and improving accuracy of EF.

In one or more embodiments of the aforementioned system, the at least one of the computer executable components can further remove terms that correlate opposite-spin species to make the Jastrow ansatz of local unitary cluster type, wherein the Jastrow ansatz is a product of terms, and wherein each of the terms act on a half of the electronic structure. Such embodiments of the system can provide a number of advantages, including reducing the ground state energy of the electronic structure, improving processing efficiency of quantum optimization improving accuracy of EF.

According to various embodiments, the above-described system can be implemented as a computer-implemented method or as a computer program product.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Entanglement forging (EF) is a quantum algorithm that leverages entanglement (e.g., where two or more quantum particles become interconnected in such a way that the state of one particle instantly influences the state of the other(s), regardless of the distance between them) and spin symmetries in a quantum system to reduce the number of qubits required by the quantum system in half for simulating the electronic structure of the full system. In particular, EF is a method for studying Eigenstates of interacting-electron Hamiltonians. A Hamiltonian represents a total energy of a system. For systems with interacting electrons, the Hamiltonian includes terms that account for electron-electron interactions. The eigenstates of the Hamiltonian are fundamental states of the system, each associated with a specific energy level. Studying these eigenstates is crucial for understanding the properties and behavior of quantum systems, such as electronic structures. In other words, EF can enable quantum simulation of electronic structures.

However, EF has many limitations that can resultingly yield in ineffective and unproductive results in studying quantum systems. In applications of chemistry for simulating electronic structures, accuracy of results is crucial. That is, it's important to extract accurate information from EF for simulating electronic structures. Specifically, to determine an energy of a quantum system, EF receives an input of quantum states for the calculation. Existing techniques receive bitstrings that represent the quantum states as the input. Unfortunately, bitstrings can often lead to very inaccurate results. In particular, EF involves an ad-hoc selection procedure of the bitstrings, which can result in inconsistent results and suboptimal performance since the selected bitstrings may not accurately represent the optimal quantum states. Ad-hoc selection of the bitstrings also exhibits limited scalability as the problem size grows. Moreover, choosing and optimizing the bitstrings can be challenging, making them impractical for simulation of electronic structures. The shortcomings of EF further include the use of heuristic hop-gates based ansatz which often lacks chemical insight, leading to suboptimal performance as it relies on predefined rules or approximations that may not fully exploit the capabilities of the quantum system. Consequently, a more accurate and efficient method for simulating electronic structures with EF can be desirable.

In addition to such limitations of EF, EF is computationally expensive. To achieve a higher level of accuracy in results from EF, a very larger number of terms are needed in computation. However, such large number of terms can lead to high computation costs, as well as further difficulty in optimization, causing even higher computation costs. Such high computation costs can make simulation of the electronic structures impractical for larger systems. As a result, a method for simulating electronic structures with EF at lower computation costs that are not at the expense of accuracy can be desirable.

In view of the problems discussed above, in relation to EF of an electronic structure for quantum operations, the present disclosure can be implemented to produce a solution to one or more of these problems by generalizing EF with Slater determinants. More specifically, generalized entanglement forging (GEF) can produce a solution to one or more of these problems by preparing a set of classical reference states that are Slater determinants to represent the quantum states of an electronic structure as input to EF, thereby achieving a higher accuracy than EF, lower computation costs than EF, while preserving the reduction in qubit requirements. The set of classical reference states can provide a more accurate approximation for a state of an electronic structure than bitstrings. That is, the set of classical reference states can be adapted from coupled cluster with singles and doubles (CCSD) for GEF, thereby providing more accurate approximations of states of an electronic structure by being chemically motivated. CCSD is a classical method used in chemistry for calculating electronic structures of molecules, and in particular, for approximately solving the Schrodinger equation (e.g., describes a quantum state of a system with interacting particles, such as electrons in a molecule) by finding the wave functions of electrons in a molecule. In other words, CCSD is an approximate method of solving for the quantum mechanical behavior of electrons in a molecule that scales polynomially in system size. Therefore, by using set of classical reference states as input in GEF to compute an energy of the electronic structures, the accuracy, efficiency and computation costs of simulating the electronic structures can be improved. Furthermore, by adapting low-rank decomposition of the measurement operator, GEF can reduce the computation costs and quantum resources of simulating the electronic structures. Moreover, GEF can additionally improve efficiency compared to EF by utilizing a Jastrow ansatz instead of hop-gates, improving the ansatz beyond a product of hop-gates.

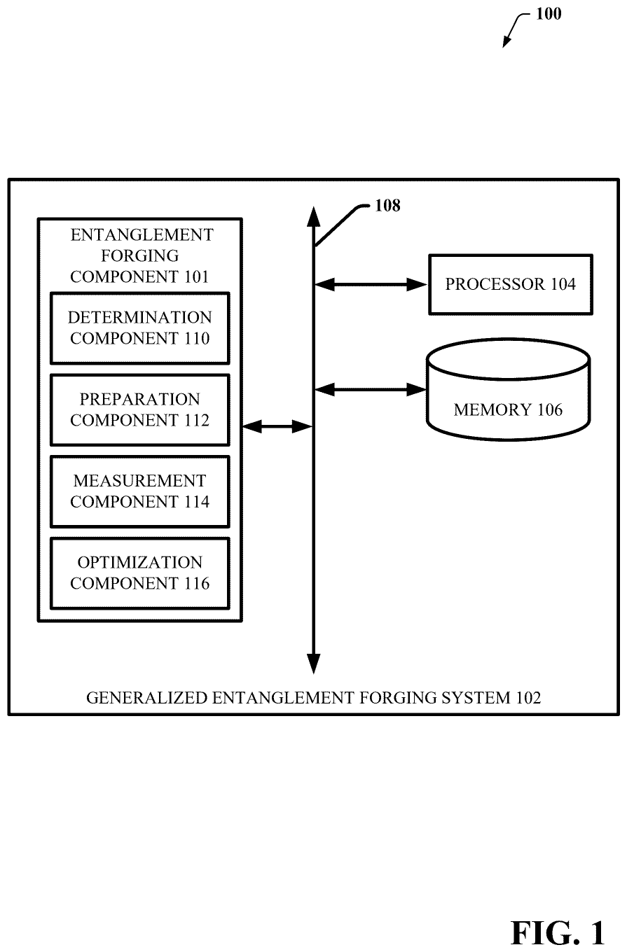

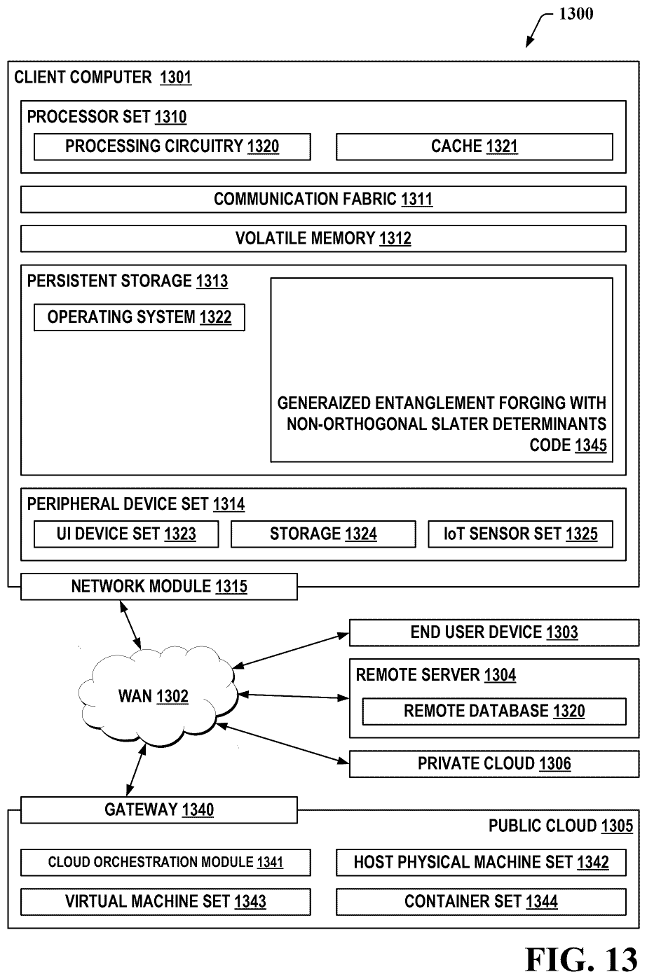

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 (e.g., system 100) as illustrated at FIG. 1, and/or systems thereof, can further comprise, be associated with and/or be coupled to one or more computer and/or computing-based elements described herein with reference to an operating environment, such as the operating environment 1300 illustrated at FIG. 13. For example, system 100 can be associated with, such as accessible via, a computing environment 1300 described below with reference to FIG. 13, such that aspects of processing can be distributed between system 100 and the computing environment 1100. In one or more described embodiments, computer and/or computing-based elements can be used in connection with implementing one or more of the systems, devices, components and/or computer-implemented operations shown and/or described in connection with FIG. 1 and/or with other figures described herein.

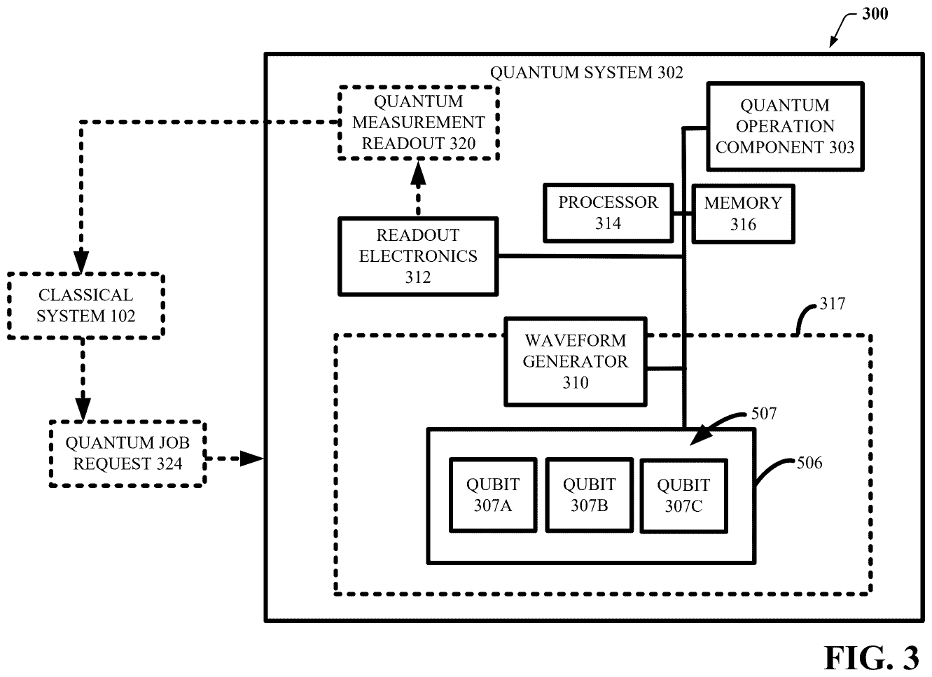

FIG. 1 illustrates block diagram of an example, non-limiting system 100 that can facilitate generalized entanglement forging with Slater determinants of an electronic structure for quantum operations in accordance with one or more embodiments described herein. That is, the non-limiting system 100 can facilitate generalized entanglement forging with Slater determinants of an electronic structure for quantum operations, in combination with employment of a quantum system 302 (FIG. 3). Aspects of systems (e.g., generalized entanglement forging system 102 and the like), apparatuses or processes in various embodiments of the present invention, can constitute one or more machine-executable components embodied within one or more machines (e.g., embodied in one or more computer readable mediums (or media) associated with one or more machines). Such components, when executed by the one or more machines (e.g., computers, computing devices, virtual machines, etc.), can cause the machines to perform the operations described.

Generalized entanglement forging system 102 can comprise processor 103, memory 106, and entanglement forging component 101, the entanglement forging component 101 comprising determination component 110, preparation component 112, measurement component 114 and/or optimization component 116.

System 100 and/or the components of system 100 can be employed to use hardware and/or software to solve problems that are highly technical in nature (e.g., related to quantum computing, entanglement forging, variational optimization, etc.), that are not abstract and that cannot be performed as a set of mental acts by a human. Further, some of the processes performed may be performed by specialized computers for carrying out defined tasks related to entanglement forging in quantum environments. The system 100 and/or components of the system can be employed to solve new problems that arise through advancements in technologies mentioned above, quantum computing, and/or the like. The system 100 can provide technical improvements in terms of generalizing entanglement forging by improving processing efficiency, improving accuracy, improving scalability of evaluation of energy, etc.

Discussion turns briefly to processor 103, memory 106 and bus 108 of system 100. For example, in one or more embodiments, the system 100 can comprise processor 103 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 103 to enable performance of one or more processes defined by such component(s) and/or instruction(s).

In one or more embodiments, system 100 can comprise a computer-readable memory (e.g., memory 106) that can be operably connected to the processor 103. Memory 106 can store computer-executable instructions that, upon execution by processor 103, can cause processor 103 and/or one or more other components of system 100 (e.g., entanglement forging component 101, determination component 110, preparation component 112, measurement component 113, optimization component 116) to perform one or more actions. In one or more embodiments, memory 106 can store computer-executable components (e.g., entanglement forging component 101, determination component 110, preparation component 112, measurement component 113, optimization component 116).

System 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

As described above, in addition to the processor 103 and/or memory 106 described above, system 100 can comprise one or more computer and/or machine readable, writable and/or executable components and/or instructions that, when executed by processor 103, can enable performance of one or more operations defined by such component(s) and/or instruction(s).

Turning to FIG. 3, one or more embodiments described herein can include one or more devices, systems and/or apparatuses that can provide a process to facilitate generalized entanglement forging with Slater determinants of an electronic structure for quantum operations. Accordingly, at FIG. 3, illustrated is a block diagram of an example, non-limiting system 300 that can at least partially facilitate such a process. While referring here to one or more processes, facilitations and/or uses of the non-limiting system 300, description provided herein, both above and below, also can be relevant to one or more other non-limiting systems described herein, such as the non-limiting systems 100, 200, and/or 300.

As illustrated at FIG. 3, the non-limiting system 300 can comprise a quantum system 302 that can be employed with or separate from the classical system 102.

Generally, the quantum system 302 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 320, can be responsive to the quantum job request 324 and associated input data and can be based at least in part on the input data, quantum functions and/or quantum computations.

In one or more embodiments, the quantum system 302 can comprise components, such as a quantum operation component 303, a quantum processor 306, pulse component 310 (e.g., a waveform generator) and/or a readout electronics 312 (e.g., readout component). In one or more other embodiments, the readout electronics 312 can be comprised at least partially by the classical system 102 and/or be external to the quantum system 302. The quantum processor 306 can comprise one or more, such as plural, qubits 307. Individual qubits 307A, 307B and 307C, for example, can be fixed frequency and/or single junction qubits, such as transmon qubits.

In one or more embodiments, a memory 316 and/or processor 313 can be associated with the quantum operation component 303, where suitable. The processor 313 can be any suitable processor. The processor 313 can generate one or more instructions for controlling the one or more processes of the quantum operation component 303.

The quantum operation component 303 can obtain (e.g., download, receive, search for and/or the like) a quantum job request 324 requesting execution of one or more quantum programs and/or a physical qubit layout. The quantum job request 324 can be provided in any suitable format, such as a text format, binary format and/or another suitable format. In one or more embodiments, the quantum job request 324 can be obtained by a component other than of the quantum system 302, such as a by a component of the classical system 102.

The quantum operation component 303 can determine mapping of one or more quantum logic circuits for executing a quantum program. In one or more embodiments, the quantum operation component 303 and/or quantum processor 306 can direct the waveform generator 310 to generate one or more pulses, tones, waveforms and/or the like to affect one or more qubits 307, such as in response to a quantum job request 324.

The waveform generator 310 can generally cause the quantum processor 306 to perform one or more quantum processes, calculations and/or measurements by creating a suitable electro-magnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 307 comprised by the quantum system 302.

The quantum processor 306 and a portion or all of the waveform generator 310 can be contained in a cryogenic environment, such as generated by a cryogenic environment 317, such as effected by a dilution refrigerator. Indeed, a signal can be generated by the waveform generator 310 to affect one or more of the plurality of qubits 307. Where the plurality of qubits 307 are superconducting qubits, cryogenic temperatures, such as about 3K or lower, can be employed for function of these physical qubits. Accordingly, one or more elements of the readout electronics 312 also can be constructed to perform at such cryogenic temperatures.

The readout electronics 312, or at least a portion thereof, can be contained in the cryogenic environment 317, such as for reading a state, frequency and/or other characteristic of qubit, excited, decaying or otherwise.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

EF is a quantum algorithm that can facilitate the study of eigenstates of interacting Hamiltonians. Turning back to FIG. 1, in various aspects, determination component 110 can, as described herein, partition a Hamiltonian H that represents an electronic structure into subsystems, wherein the electronic structure can be represented by M qubits. That is, the determination component 110 can partition the Hamiltonian H into a subsystem A and a subsystem B, where subsystem A comprises N_{A} qubits and subsystem B comprise N_{B}=M−N_{A} qubits. Accordingly, the Hamiltonian H can be formulated as a linear combination of terms acting on subsystem A and subsystem B, defined by

$$H = {\sum }_{μ = 1}^{{N}_{h}} {A}_{μ} ⊗ {β}_{μ} .$$

The ground state of the electronic structure can then be approximated by a wavefunction that represents the electronic structure, wherein the wavefunction can be formulated as a linear combination of the terms acting on subsystem A and subsystem B, defined by |Ψ [symbol] ≈Σ_{x∈S}λₓU|x [symbol] ⊗V|x [symbol] , for a fixed set of bitstrings S and ansatzes U and V. Further, in various aspects, the quantum states can be optimized to minimize an energy function

$$E = {\sum }_{μ = 1}^{{N}_{h}} {\sum }_{xy ∈ S} {λ}_{x}^{*} {λ}_{y} 〈 x \vert {U}^{†} {A}_{μ} U \vert y 〉 〈 x \vert {V}^{†} {B}_{μ} V \vert y 〉 .$$

However, the set of bitstrings can be generalized to a set of classical reference states that can be efficiently and classically prepared.

In various embodiments, determination component 110 can, as described herein, determine and initialize the set of classical reference states. The classical reference states can represent quantum states of the electronic structure. The classical reference states can replace bitstrings in EF to represent the quantum states of the electronic structure. In various aspects, the set of classical reference states can be Slater determinants. In various instances, the determination component 110 can generate linear combinations of the Slater determinants for input into GEF. The determination component 110 can generate the linear combinations efficiently by employing a Hadamard test with linear depth. Furthermore, the determination component 110 can generate the linear combinations with the Hadamard test can eliminate a need for post-selection on measurement outcomes as different measurement outcomes correspond to different superposition states, further improving processing efficiency. In various aspects, the Slater determinants can be derived classically through various methods, such as stochastic compilation of imaginary-time evolutions (e.g., stochastic techniques to compile and optimize quantum circuits that simulate imaginary-time evolution to find the ground state of a quantum system), stochastic compilation of a CCSD wavefunction (e.g., stochastic methods to develop and refine quantum circuits that efficiently represent and compute the Coupled Cluster with Single and Double excitations (CCSD) wavefunction).

In various embodiments, preparation component 112 can, as described herein, prepare diagonal states and superposition states of the Slater determinants for inputting the quantum states into GEF. In various aspects, preparation component 112 can further, as described herein, initialize an ansatz of local unitary cluster Jastrow type based on CCSD. In various aspects, the ansatz of local unitary cluster Jastrow type can enable hardware-efficient unitary coupled cluster by promoting the classical CCSD ansatz to a unitary operator (e.g., transforming an initial quantum state ansatz into a unitary operator that can be applied to a quantum system).

In various embodiments, the measurement component 114 can, as described herein, obtain measurements of qubits that represent quantum states of the subsystems over the GEF quantum circuit based on the Slater determinants and the ansatz of local unitary cluster Jastrow type. Accordingly, the determination component 110 can combine the measurements (e.g., sum terms of the Hamiltonian) to determine an energy of the electronic structure.

In various embodiments, the optimization component 116 can, as described herein, using the determined energy of the electronic structure, variationally optimize the energy function. That is, the optimization component 116 can use the energy function E as a cost function within variational optimization to minimize the energy function E over a set of variational parameters of the wavefunction ansatz that represents the electronic structure.

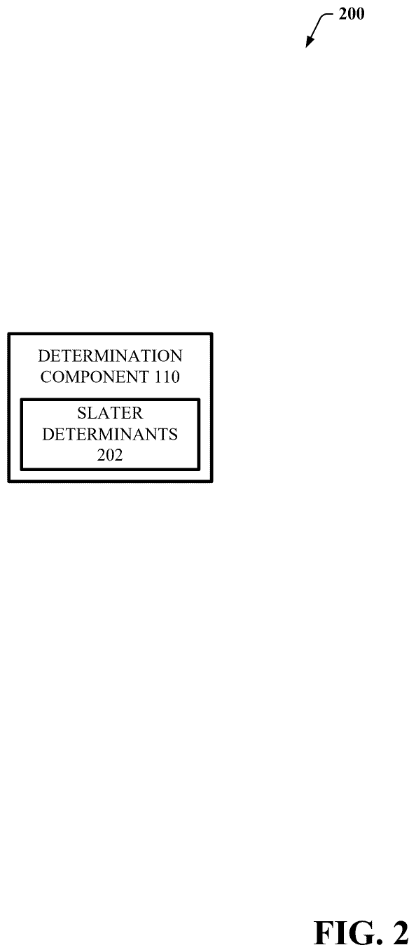

FIG. 2 illustrates an example, non-limiting block diagram 200 including Slater determinants that can facilitate generalized entanglement forging with Slater determinants of an electronic structure for quantum operations in accordance with one or more embodiments described herein.

In various embodiments, the determination component 110 can prepare the classical reference states. More specifically, the determination component 110 can prepare the classical reference states as Slater determinants 202.

Determination of the Slater determinants 202 for GEF can be motivated by CCSD. That is, CCSD suggests how to generalize EF with Slater determinants instead of bitstrings in EF, thereby improving accuracy and reducing computational costs of EF. CCSD is defined by wavefunction

$$\vert {Ψ}_{CCSD} 〉 = {e}^{T} \vert {Φ}_{HF} 〉 ,$$

$$T = {( {t}_{1 α} )}_{ai} {E}_{ai}^{α} + {( {t}_{1 β} )}_{BJ} {E}_{BJ}^{β} + {( {t}_{2 αα} )}_{aibj} {E}_{aibj}^{αα} + {( {t}_{2 ββ} )}_{AIBJ} {E}_{AIBJ}^{ββ} + {( {t}_{2 αβ} )}_{aiBJ} {E}_{aiBJ}^{αβ} ,$$

where T denotes a cluster operator that describes electron correlation effects, E denotes excitation energy that promotes electrons from occupied orbitals to unoccupied orbitals, t₁ denotes a single excitation amplitude, and t₂ denotes a double excitation amplitude. Moreover, a, A, b, and B denote unoccupied orbitals and i, l, j, and J denote occupied orbitals. Further, α and β denote opposite spins of electrons (e.g., spin-α electrons, spin-β electrons).

In various embodiments, the determination component 110 can determine the Slater determinants 202 by decomposing the cluster operator T using singular value decomposition of the opposite-spin amplitude tensor, (t_{2αβ})_{aiBJ}=Σ_{δ}τ_{δ}U_{ai,δ}V_{BJ,δ}, into a sum of same-spin terms and squares of one-body operators (e.g., operators that affect a single electron), defined by

$$T = {( {t}_{1 α} )}_{ai} {E}_{ai}^{α} + [ {( {t}_{2 αα} )}_{aibj} - {\sum }_{δ} \frac{{τ}_{δ}}{2} {U}_{ai , δ} {U}_{bj , δ} ] {E}_{aibj}^{αα} + {( {t}_{1 β} )}_{BJ} {E}_{BJ}^{β} + [ {( {t}_{2 ββ} )}_{AIBJ} - {\sum }_{δ} \frac{{τ}_{δ}}{2} {V}_{AI , δ} {V}_{BJ , δ} ] {E}_{AIBJ}^{ββ} + {\sum }_{δ} \frac{{X}_{δ}^{2}}{2} ,$$

$$where {X}_{δ} = \sqrt{{τ}_{δ}} [ {U}_{ai , δ} {E}_{ai}^{α} + {V}_{BJ , δ} {E}_{BJ}^{β} ] ,$$

which can be simplified to the following equation:

$$T = {T}_{1 α} + {\tilde{T}}_{2 αα} + {T}_{1 β} + {\tilde{T}}_{2 ββ} + {\sum }_{δ} \frac{{X}_{δ}^{2}}{2} .$$

Since same-spin terms (e.g., T_{1α}+T_{2αα} and T_{1β}+T_{2ββ}) do not create entanglement between spin-α electrons and spin-β electrons, the determination component 110 can apply a Hubbard-Stratonovich transformation on the opposite-spin terms X_{δ}, yielding the following equation:

|Ψ_{CCSD} [symbol] =(e^{T}^{_{1α}}^{+\tilde{T}}^{_{2αα}}⊗e^{T}^{_{1β}}^{+\tilde{T}}^{_{2ββ}})∫dyp(y)|φ(y) [symbol] , where the states are non-orthogonal Slater determinants defined by |(y) [symbol] =e^{Σ}^{_{δ}}^{y}^{_{δ}}^{x}^{_{δ}}|φ_{HF} [symbol] .

As a result, CCSD suggests replacing bitstrings with the Slater determinants 202. More specifically, defining the Slater determinants 202 by such non-orthogonal Slater determinants can provide a number of advantages, including enabling efficient sampling from the Hubbard-Stratonovich distribution, improving processing efficiency by variationally optimizing the auxiliary fields y, and enabling efficient full variational optimization of the Slater determinants 202. Thus, the determination component 110 can efficiently determine the Slater determinants 202.

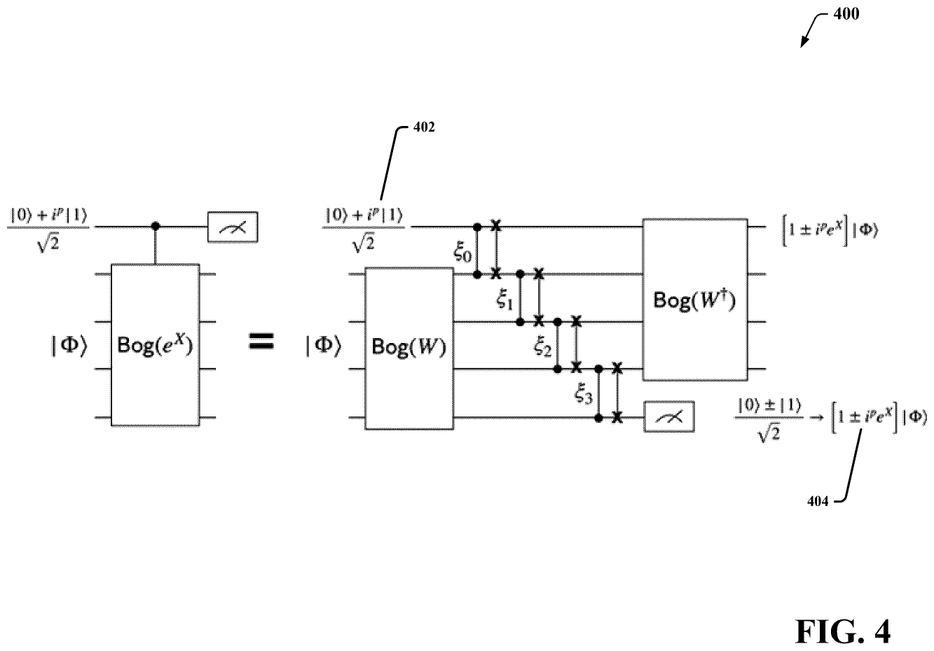

FIG. 4 illustrates a diagram of an example, non-limiting quantum circuit 400 that can prepare superpositions of Slater determinants in accordance with one or more embodiments described herein.

In various embodiments, the preparation component 112 can prepare superposition states of the Slater determinants 202 for inputting the quantum states into EF. In order to evaluate the energy function E, GEF requires preparing states

$$\vert {α}_{kl}^{p} 〉 = \frac{\vert {α}_{kl} 〉 + {i}^{p} \vert {α}_{l} 〉}{\sqrt{2 + 2 Re [ {i}^{p} 〈 {a}_{k} \vert {a}_{l} 〉}} ,$$

which further requires preparing superposition states of the Slater determinants 202. In various aspects, the preparation component 112 can employ the non-limiting quantum circuit 400 to prepare a superposition of two of the Slater determinants 202, thereby yielding quantum states of form

$$\frac{\vert Φ 〉 + {i}^{p} \vert Ψ 〉}{\sqrt{2 + 2 Re [ {i}^{p} 〈 Φ \vert Ψ 〉}} ∝ ( 1 + {i}^{p} {e}^{X} ) \vert Φ 〉 , where X = {\sum }_{pr} {x}_{pr} {\hat{α}}_{p}^{†} {\hat{α}}_{r} , \\ {X}^{†} = - X \to {x}_{pr} = {\sum }_{q} {W}_{pq} i {ξ}_{q} {W}_{qr}^{†} , and {e}^{X} = {W}^{†} {e}^{i {\sum }_{q} {ξ}_{q} {\hat{α}}_{q}^{†} {\hat{α}}_{q}} W .$$

In various embodiments, the non-limiting quantum circuit 400 achieves a circuit depth of 2 (M+1)+2M which scales as O(M) with a total of

$$2 [ \frac{( M - 1 ) M}{2} + M ] + 2 M$$

gates, which scales as O(M²).

In various aspects, the non-limiting quantum circuit 400 can apply a Bogoliubov transformation gate and a series of phase adjustments to prepare superpositions states of the Slater determinants 202. Such transformation and phase adjustments can transform an initial state 402 of

$$\frac{\vert 0 〉 + {i}^{p} \vert 1 〉}{\sqrt{2}}$$

into a final state 404 of [1+i^{p}e^{x}]|Φ [symbol] . Therefore, the non-limiting quantum circuit 400 can also enable efficient mapping of quantum states.

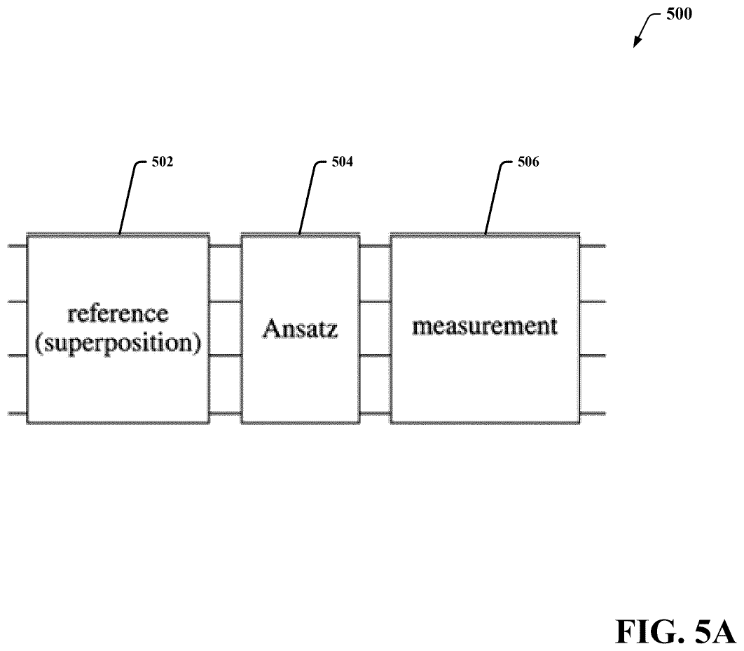

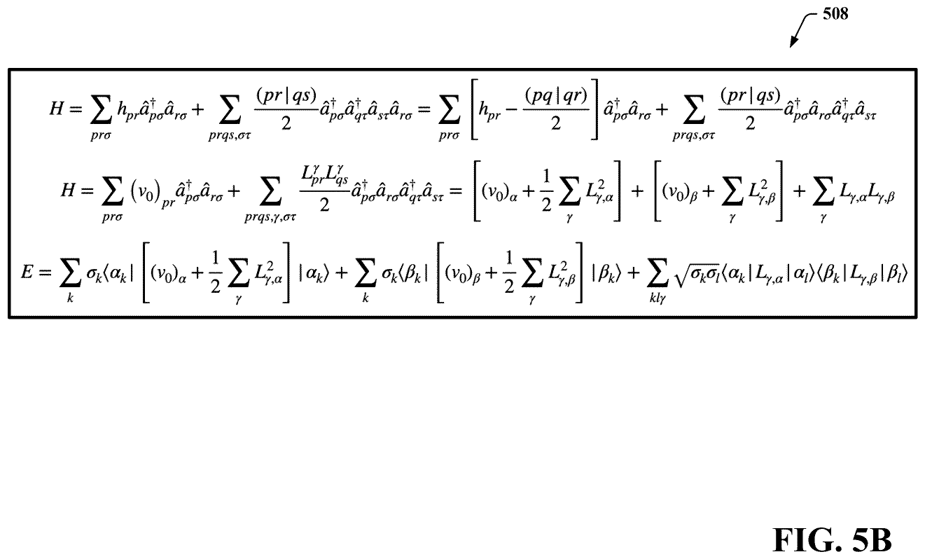

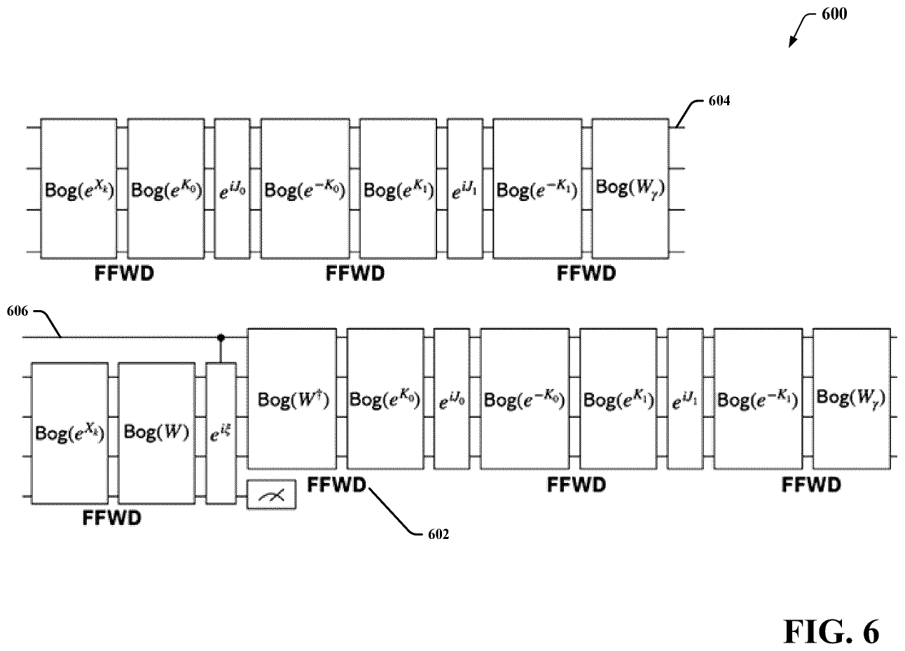

FIGS. 5A and 6 illustrate a diagram of an example, non-limiting quantum circuit 500 and 600 that can facilitate generalized entanglement forging with Slater determinants in accordance with one or more embodiments described herein.

FIG. 5A illustrates a diagram of an example, non-limiting quantum circuit 500 that can facilitate generalized entanglement forging with Slater determinants in accordance with one or more embodiments described herein.

In various embodiments, a GEF quantum circuit can comprise a general structure of the non-limiting quantum circuit 500. More specifically, the GEF quantum circuit can comprise three segments, the three segments comprising classical reference state preparation 502, ansatz application 504, and measurements 506.

In various aspects, classical reference state preparation 502 can involve preparation of the Slater determinants 202. Further, classical reference state preparation 502 can involve preparation of superposition states of the Slater determinants 202. As described supra, the preparation component 112 can prepare the superposition states of the Slater determinants 202 with the non-limiting quantum circuit 400. In various instances, ansatz application 504 can involve applying an ansatz of local unitary cluster Jastrow type that are local unitary transformations on clustered particles with a Jastrow factor that describes correlations within the system. In various aspects, the ansatz parameters can be initialized based on CCSD from a classical electronic structure calculation. Consider CCSD expressed in terms of the Slater determinants 202:

$$\vert {Ψ}_{CCSD} 〉 ≃ ( {e}^{{T}_{1 α} + {\tilde{T}}_{2 αα}} ⊗ {e}^{{T}_{1 β} + {\tilde{T}}_{2 ββ}} ) {\sum }_{k = 0}^{d - 1} {c}_{k} \vert {Φ}_{{C}_{k}^{α} , {C}_{k}^{β}} 〉 .$$

This suggests promoting the ansatz of CCSD to a local unitary operator, such that e^{T}^{_{1α}}^{+T}^{_{2αα}}→e^{T}^{_{1α}}^{-T}^{_{1α}}^{^{†}}e^{T}^{_{2α}}^{α-T}^{_{2αα}}^{^{†}} In various aspects, the preparation component 112 can thus reformulate the two-body operators into Jastrow form, yielding e^{T}^{_{2αα}}^{-T}^{_{2αα}}^{^{†}}=Π_{μ}e^{-K}^{_{μ}}e^{iJ}^{_{μ}}e^{K}^{_{μ}}, where

$${K}_{μ} = {\sum }_{pr} {κ}_{pr}^{μ} {\hat{a}}_{p}^{†} {\hat{a}}_{r} , {K}_{μ}^{†} = - {K}_{μ} , and {J}_{μ} = {\sum }_{pr σ} {J}_{pr}^{μ} [ {\hat{a}}_{p}^{†} {\hat{a}}_{p} ] [ {\hat{a}}_{r}^{†} {\hat{a}}_{r} ] .$$

Accordingly, the ansatz of local unitary cluster Jastrow type can achieve a circuit depth of O(M) with a total number of gates (e.g., or parameters) of O(M²) and linear qubit connectivity.

In various embodiments, measurements 506 can comprise obtaining measurements of a term in the Hamiltonian. In various aspects, the measurement component 114 can decompose the Hamiltonian to reduce measurement costs from O(M⁴d²) to O(Md²). The measurement component 114 can pre-process the Hamiltonian using the non-limiting procedure 508 depicted in FIG. 5B to achieve such linear scaling of Hamiltonian measurement.

In various aspects, the measurement component 114 can decompose the Hamiltonian using a low-rank decomposition of electron repulsion integrals (pr|qs)=Lγpr Lγqs (e.g., integrals that describe the interaction between electron pairs in different spatial orbitals) and adapt it for GEF. Thus, the low-rank decomposition can be leveraged to divide an n-qubit problem into two (n/2)-qubit problems by decomposing the Hamiltonian into parts that act on the (n/2)-qubit subsystems. In the adapted low-rank decomposition, (pr|qs) represents the electron repulsion integral between orbitals p, q, r, and s, and Lγpr and Lγqs are matrices resulting from the low-rank decomposition that represent approximations of the electron repulsion integral in terms of lower-dimensional matrices, enabling more efficient computation within GEF.

The low-rank decomposition comprises one-body operators (v₀, L_{γ}), squares of one-body operators (L_{γ}), and a sum over an index γ ranging over N_{γ}=O(M) terms. In various instances, the measurement component 114 can, for each term (v₀, L_{γ}) in the Hamiltonian, append a Bogolyubov transformation that diagonalizes the term and measure qubits in a computational basis. Thus, the measurements can be combined to compute expectation values of the term in the Hamiltonian.

In various aspects, determination of the energy function E involves measuring individual terms on the quantum computer and then summing them on a classical computer. Two types of quantum circuits are needed to determine the energy function E (e.g., diagonal quantum circuit 604 and superposition quantum circuit 606). Referencing the non-limiting procedure 508, the first type of quantum circuit involves measurement of terms over the same indices k, defined in the energy function E as shown. For example, the terms over the same indices k can include terms in the first and second summation, as well as terms where k=l in the third summation, as shown in the energy function E defined in the non-limiting procedure 508. The second type of quantum circuit involves estimation of terms that have different k and/indices, which are only present in the third summation. These terms are obtained using the superposition quantum circuits.

Turning to FIG. 6, the non-limiting quantum circuits 600 depicts an example quantum circuit comprising the structure of non-limiting quantum circuit 500 with non-orthogonal Slater determinants (e.g., Slater determinants 202), an ansatz of local unitary cluster Jastrow type, and the low-rank representation of the Hamiltonian. In various embodiments, measurement component 113 can execute the non-limiting quantum circuits 600 as the GEF quantum circuit to evaluate the energy function. In various aspects, the non-limiting quantum circuits 600 can comprise a diagonal quantum circuit 604 and a superposition quantum circuit 606. In various embodiments, the diagonal quantum circuit 604 is for the diagonal terms (e.g., terms where k=l in the third summation, and terms from the first and second summations in the energy function E) to create diagonal states. In other aspects, superposition quantum circuit 606 is for off-diagonal terms or the superposition-terms (e.g., terms where k≠l) to create the superposition states.

As shown, the non-limiting quantum circuits (diagonal quantum circuit 604 and superposition quantum circuit 606) 600 can achieve a linear gate depth, thereby improving scalability of EF. Furthermore, the non-limiting quantum circuits 600 can employ a fast-forwarding property 602 to combine contiguous Bogolyubov transformation circuits into one Bogolyubov transformation circuit, thereby reducing the required circuit depth and quantum gates as well as increasing the accuracy of the quantum computation by tailoring the quantum circuit to efficiently compute the diagonal and off-diagonal terms in the energy function.

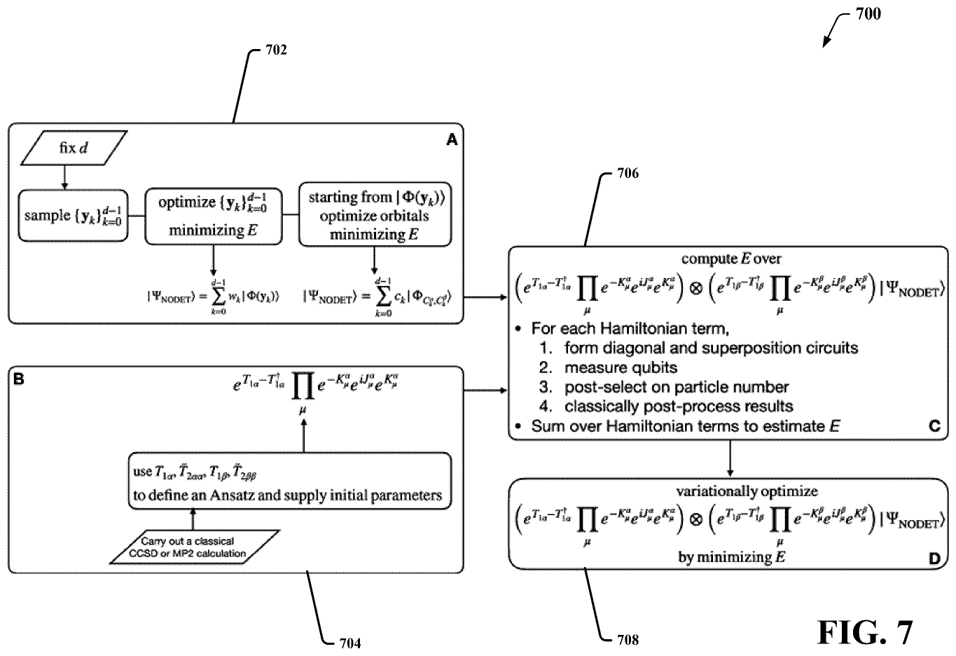

FIG. 7 illustrates an example, non-limiting diagram 700 showing a workflow of entanglement forging with Slater determinants in accordance with one or more embodiments described herein.

In various embodiments, as shown in block 702, the determination component 110 can determine the Slater determinants 202 and optimize the Slater determinants 202 for EF. In various aspects, the determination component 110 can receive a degree d that defines a number of the Slater determinants to prepare. Accordingly, the determination component 110 can efficiently sample d Slater determinants 202 from the Hubbard-Stratonovich distribution

$${\{ {y}_{k} \}}_{k = 0}^{d - 1} .$$

In various aspects, the optimization component 116 can optimize the Slater determinants 202 using a sequence of classical variational optimizations. Specifically, the optimization component 116 can optimize the Slater determinants 202 to minimize the energy function E. Further, the optimization component 116 can, starting from a quantum state of |Φ(yₖ)), optimize orbitals of the electronic structure to minimize the energy function E. Such series of classical variational optimizations can yield the Slater determinants 202, where the Slater determinants 202 are non-orthogonal, and wherein the Slater determinants 202 are characterized by an α-spin or a β-spin of the electron (e.g., C_{α}, C_{β}).

In various embodiments, as shown in block 704, the preparation component 112 can initialize the ansatz of Jastrow type based on CCSD calculations. That is, the preparation component 112 can initialize the ansatz using the α-spin and β-spin terms T_{1α}, \tilde{T}_{2αα}, T_{1β}, and \tilde{T}_{2ββ}.

For instance, the preparation component 112 can define the ansatz by a product of

$${e}^{{T}_{1 α} - {T}_{1 α}^{†}} {\prod }_{μ} {e}^{- {K}_{μ}^{α}} {e}^{{iJ}_{μ}^{α}} {e}^{{K}_{μ}^{α}} and {e}^{{T}_{1 β} - {T}_{1 β}^{†}} {\prod }_{μ} {e}^{- {K}_{μ}^{β}} {e}^{{iJ}_{μ}^{β}} {e}^{{K}_{μ}^{β}} .$$

In this form, the ansatz is a product (e.g., tensor product) of two terms, wherein each term acts on a half of the electronic structure. That is, a first term of the two terms can act on electrons with an α-spin and a second term of the two terms can act on electrons with a β-spin. In various aspects, the ansatz can use the coupled cluster state in combining the terms to provide a quantum circuit for GEF that refines calculations of the quantum state. Thus, the ansatz can correlate the Slater determinants to achieve improved accuracy in addition to the improved accuracy provided by using only the Slater determinants 202 by accounting for electron-electron interactions and correlation effects.

In various embodiments, as shown in block 706, based on the low-rank decomposition of the Hamiltonian and the quantum circuit (e.g., quantum circuit 400) that prepares the superpositions of the Slater determinants 202, the determination component 110 can evaluate the energy function E, which can be achieved at linear costs.

In various aspects, decomposing the Hamiltonian can comprise diagonalizing and partitioning the terms in the Hamiltonian, thereby constructing the subsystems of the electronic structure. For each term in the Hamiltonian, the measurement component 114 can measure qubits that represent quantum states of the subsystems over the GEF quantum circuit. In various instances, the measurement component 114 can post-select the measurements obtained from a quantum computer. More specifically, after performing a quantum measurement, the measurement component 114 can filter the correct measurement outcomes of a quantum computer based on a specific number of particles in a particular quantum state. In various cases, the determination component 110 can classically post-process the measurements to refine the raw data into meaningful results. In various embodiments, determination component 110 can evaluate the energy function based on the results by combining the measurements of the subsystems. In other words, the determination component 110 can sum the Hamiltonian terms to determine the energy of the electronic structure.

In various aspects, as shown in block 708, the optimization component 116 can, using the energy of the electronic structure and the energy function E, variationally optimize the energy function E. In particular, the optimization component 116 can minimize the energy function E over a set of variational parameters of the wavefunction that represents the electronic structure, wherein the energy function E is used as a cost function. Thus, a ground state can be approximated by GEF as the lowest energy state of the electronic structure (e.g., when the electronic structure Hamiltonian is for a molecule in equilibrium).

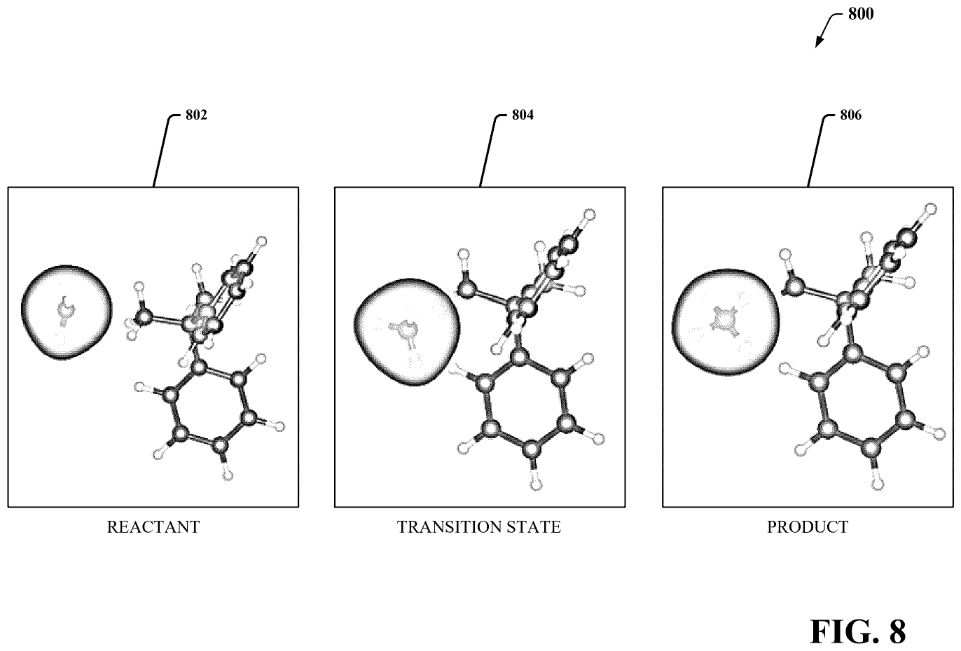

FIGS. 8-10 illustrate example, non-limiting diagrams 800, 900, and 1000 showing performance results of generalized entanglement forging with Slater determinants of an electronic structure for quantum operations in accordance with one or more embodiments described herein.

Turning to FIG. 8, as a non-limiting example, GEF with Slater determinants can be employed to estimate an activation barrier linked to a reaction, and in particular to the hydrogen abstraction process. As shown, the hydrogen abstraction process can comprise stage 802, stage 804, and stage 806. In stage 802, there can be a reactant (e.g., an atom, a molecule), such as a polymer, and a radical species. In stage 804 (e.g., a transition state) the radical species can react with the reactant by beginning to abstract an electron and a proton (e.g., a Hydrogen atom) from the reactant. In stage 806, there can be a product, such that the radical species fully abstracts the electron from the reactant, causing the reactant to become destabilized and further causing a chemical environment to degrade. This can impact stability and properties of materials like polymers. Therefore, it can be desirable to determine the energy associated with the hydrogen abstraction process (e.g., energy differences between each stage, heat the reaction releases, energy needed to trigger the reaction).

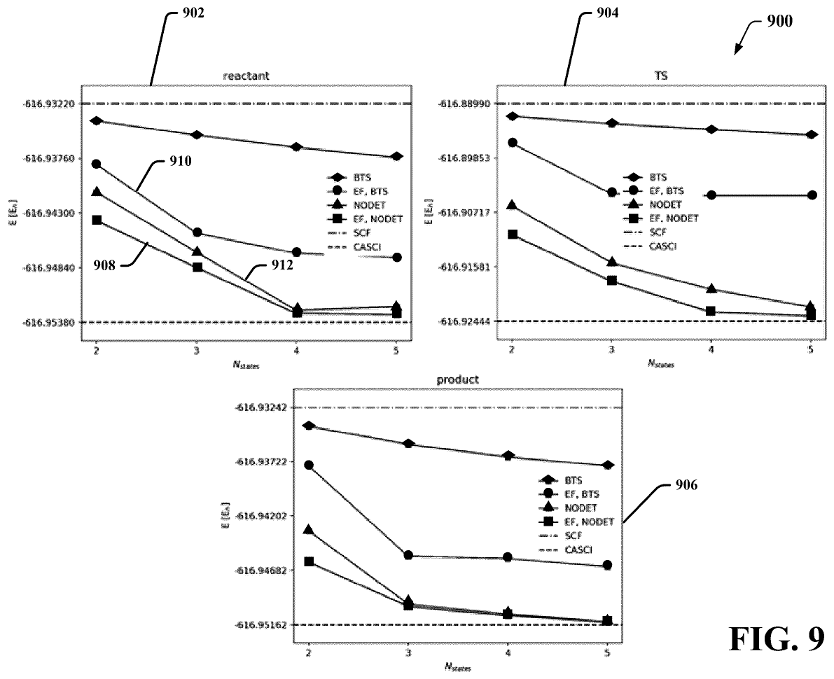

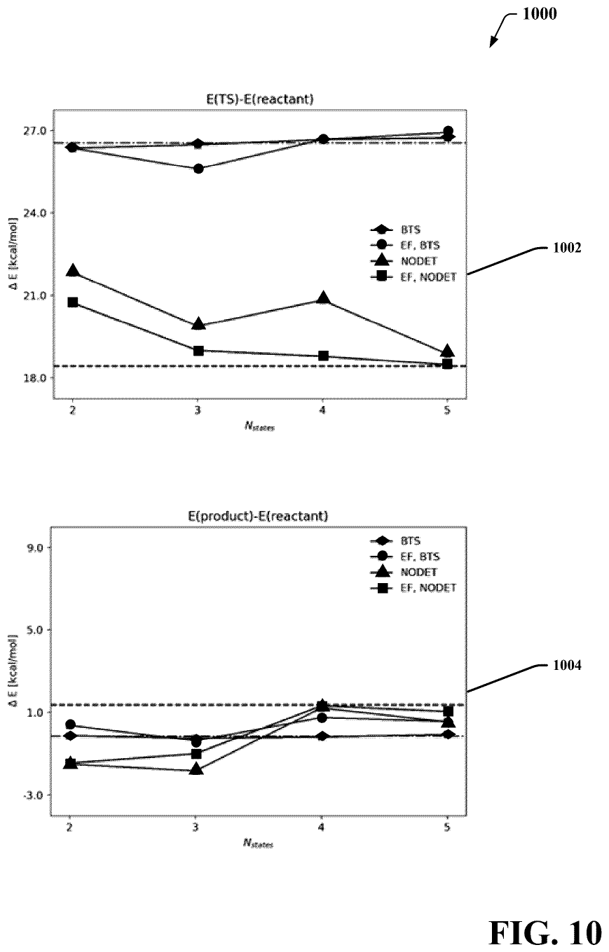

FIGS. 9 and 10 depict performance results of GEF with Slater determinants against existing methods for Hydrogen abstraction from methyl diphenylmethane by a methyl radical, or CH₃+HX→CH₄+X, X=CH₂CH(C₆H₅)₂.

Depicted in FIG. 9 are performance results of GEF with Slater determinants against existing methods to evaluate an energy of the system at stage 802, stage 804, and stage 806 of the reaction. The exact solution is represented by the dashed line, and the worst possible approximation is represented by the dotted and dashed line.

As shown in graph 902, GEF with non-orthogonal Slater determinants and the Jastrow ansatz, depicted by line 908, exhibits a significant improvement in approximating the energy of stage 802 (e.g., reactant state) over existing methods. Similarly, as shown in graph 904 and graph 906, GEF with non-orthogonal Slater determinants exhibits a significant improvement in approximating the energy of stage 804 (e.g., transition state) and stage 806 (e.g., product state) respectively over existing methods.

In particular, GEF with non-orthogonal Slater determinants exhibits significant improvement over EF with bitstrings, depicted by line 910, for all three stages of the reaction, providing approximations of the energy of the system near the exact solution. Moreover, non-orthogonal Slater determinants alone without the Jastrow ansatz, depicted by line 912, also exhibits an improvement over the existing methods. Furthermore, as shown, as the number of Slater determinants used increases, the accuracy increases.

Turning to FIG. 10, graph 1002 depicts the energy difference between stage 802 and stage 804. As shown, GEF with non-orthogonal Slater determinants and Jastrow ansatz exhibits a significant improvement in approximating the energy difference between the transition state and the reactant compared to EF with bitstrings. That is, EF with bitstrings performs similar to the Hartree-Fock method, which is an insufficient approximation, and GEF with non-orthogonal Slater determinants and Jastrow ansatz performs near the exact solution.

Graph 1004 depicts the energy difference between stage 802 and stage 806. Similarly, as shown, GEF with non-orthogonal Slater determinants and Jastrow ansatz exhibits a significant improvement in approximating the energy difference between the transition state and the product compared to EF with bitstrings. That is, EF with bitstrings performs similar to the Hartree-Fock method, which is an insufficient approximation, and GEF with Slater determinants and Jastrow ansatz performs near the exact solution, especially as the number of Slater determinants used increases. Moreover, non-orthogonal Slater determinants alone, without the Jastrow ansatz, also exhibits an improvement over the existing methods in approximating the energy differences.

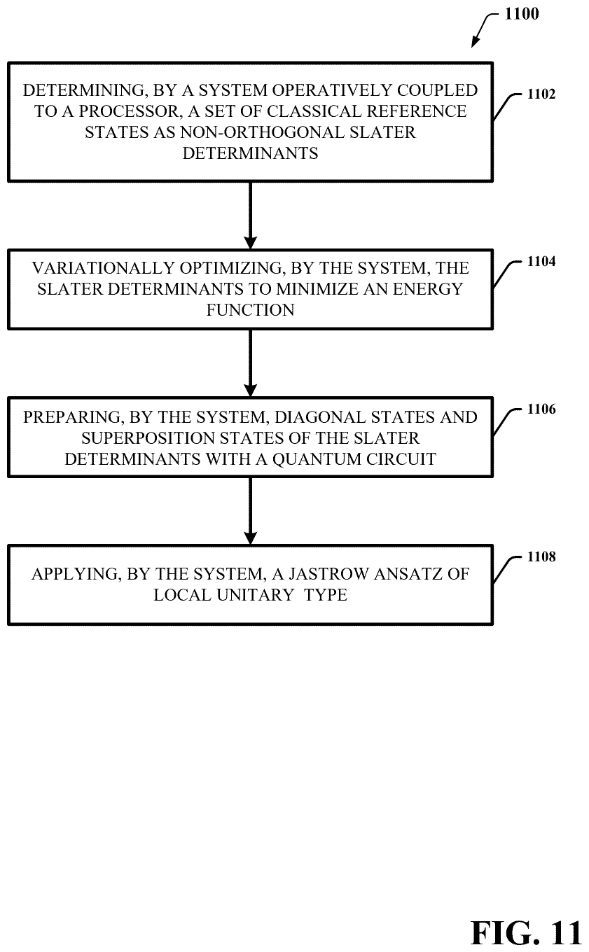

FIG. 11 illustrates a flow diagram of an example, non-limiting method 1100 that can facilitate generalized entanglement forging with Slater determinants of an electronic structure for quantum operations in accordance with one or more embodiments described herein. Repetitive description of like elements employed in other embodiments described herein is omitted for sake of brevity.

At 1102, non-limiting method 1100 can include determining, by a system (e.g., generalized entanglement forging system 102 and/or determination component 110) operatively coupled to a processor (e.g., 104), a set of classical reference states as non-orthogonal Slater determinants (e.g., Slater determinants 202).

At 1104, non-limiting method 1100 can include variationally optimizing, by the system (e.g., optimization component 116), the Slater determinants to minimize an energy function.

At 1106, non-limiting method 1100 can include preparing, by the system (e.g., preparation component 112), diagonal states and superposition states of the Slater determinants with a quantum circuit.

At 1108, non-limiting method 1100 can include applying, by the system (e.g., measurement component 114), a Jastrow ansatz of local unitary type.

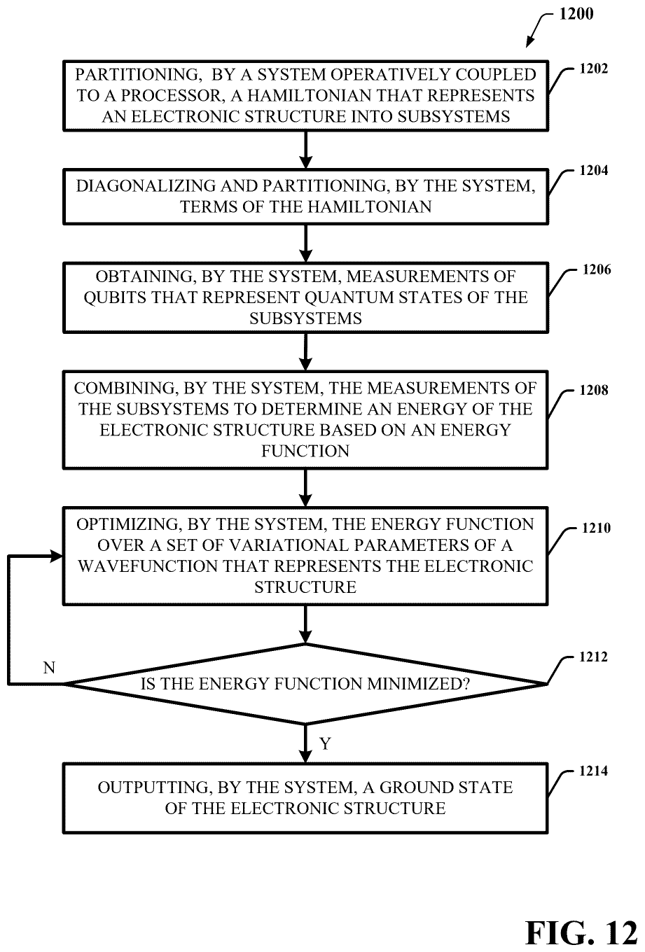

FIG. 12 illustrates a flow diagram of an example, non-limiting method 1200 that can facilitate generalized entanglement forging with Slater determinants of an electronic structure for quantum operations in accordance with one or more embodiments described herein. Repetitive description of like elements employed in other embodiments described herein is omitted for sake of brevity.

At 1202, non-limiting method 1200 can include partitioning, by a system (e.g., generalized entanglement forging system 102 and/or preparation component 112), a Hamiltonian that represents an electronic structure into subsystems.

At 1204, non-limiting method 1200 can comprise diagonalizing and partitioning, by the system (e.g., preparation component 112), terms of the Hamiltonian.

At 1206, non-limiting method 1200 can comprise obtaining, by the system (e.g., measurement component 114), measurements of qubits that represent quantum states of the subsystems.

At 1208, non-limiting method 1200 can include combining, by the system (e.g., determination component 110), the measurements of the subsystems to determine an energy of the electronic structure based on an energy function. For instance, the determination component 110 can compute a sum of the terms in the Hamiltonian.

At 1210, non-limiting method 1200 can include optimizing, by the system (e.g., optimization component 116), the energy function over a set of variational parameters of a wavefunction that represents the electronic structure.

At 1212, non-limiting method 1200 can include determining if the energy function is minimized. If yes (e.g., the energy function is minimized), the non-limiting method 1200 can proceed to 1214. If no (e.g., the energy function is not minimized), the non-limiting method 1200 can proceed to 1210.

At 1214, non-limiting method 1200 can include outputting, by the system (e.g., determination component 110), a ground state of the electronic structure.

Generalized entanglement forging system 102 can provide technical improvements to a processing unit associated with generalized entanglement forging system 102. For example, by utilizing non-orthogonal Slater determinants, determination of quantum states to input into GEF can be efficiently prepared, thereby reducing the workload of a processing unit (e.g., processor 103). In this example, by reducing the workload of such a processing unit (e.g., processor 103), generalized entanglement forging system 102 can thereby facilitate improved performance, improved accuracy, and/or reduced computational cost associated with such a processing unit. As another example, by pre-processing the Hamiltonian, linear scaling Hamiltonian measurement can be achieved. Further, by utilizing an ansatz of local unitary Jastrow type, the amount of computation resources utilized by generalized entanglement forging system 102 is reduced by leveraging a hardware-efficient version of unitary CCSD, thereby reducing or removing the additional workload of a QPU of a quantum system associated with the quantum optimization. Generalized entanglement forging system 102 can thereby facilitate improved accuracy, improved efficiency, improved performance, and/or reduced computational costs associated with a quantum processor.

A practical application of generalized entanglement forging system 102 is that it allows for ground-state simulation of molecular structures with increased accuracy and decreased computational costs by utilizing a reduced amount of quantum and classical computing resources, in comparison to other methods. For example, by using non-orthogonal Slater determinants, generalized entanglement forging system 102 can enable GEF of an electronic structure for quantum operations with improved accuracy, decreased computation costs, and improved processing efficiency. Therefore, generalized entanglement forging system 102 can enable GEF of an electronic structure for quantum operations that can be operated with reduced quantum and classical hardware requirements, thus promoting efficient and accurate quantum simulations of an electronic structure.

It is to be appreciated that generalized entanglement forging system 102 can utilize various combination of electrical components, mechanical components, and circuitry that cannot be replicated in the mind of a human or performed by a human as the various operations that can be executed by generalized entanglement forging system 102 and/or components thereof as described herein are operations that are greater than the capability of a human mind. For instance, the amount of data processed, the speed of processing such data, or the types of data processed by generalized entanglement forging system 102 over a certain period of time can be greater, faster, or different than the amount, speed, or data type that can be processed by a human mind over the same period of time. According to several embodiments, generalized entanglement forging system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that generalized entanglement forging system 102 can include information that is impossible to obtain manually by an entity, such as a human user. For example, the type, amount, and/or variety of information included in generalized entanglement forging system 102 can be more complex than information obtained manually by an entity, such as a human user.

FIG. 13 illustrates a block diagram of an example, non-limiting operating environment 1300 in which one or more embodiments described herein can be facilitated. FIG. 13 and the following discussion are intended to provide a general description of a suitable operating environment 1300 in which one or more embodiments described herein at FIGS. 1-12 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as generalized entanglement forging with Slater determinants code 1335. In addition to block 1335, computing environment 1300 includes, for example, computer 1301, wide area network (WAN) 1302, end user device (EUD) 1303, remote server 1303, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1335, as identified above), peripheral device set 1313 (including user interface (UI), device set 1325, storage 1323, and Internet of Things (IoT) sensor set 1325), and network module 1315. Remote server 1303 includes remote database 1330. Public cloud 1305 includes gateway 1330, cloud orchestration module 1331, host physical machine set 1332, virtual machine set 1333, and container set 1333.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in block 1335 in persistent storage 1313.

COMMUNICATION FABRIC 1311 is the signal conduction paths that allow the various components of computer 1301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, the volatile memory is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface type operating systems that employ a kernel. The code included in block 1335 typically includes at least some of the computer code involved in performing the inventive methods.

PERIPHERAL DEVICE SET 1313 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1325 may include components such as a display screen, speaker, microphone, wearable devices (such as goggles and smart watches), keyboard, mouse, printer, touchpad, game controllers, and haptic devices. Storage 1323 is external storage, such as an external hard drive, or insertable storage, such as an SD card. Storage 1323 may be persistent and/or volatile. In some embodiments, storage 1323 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1303 is any computer system that serves at least some data and/or functionality to computer 1301. Remote server 1303 may be controlled and used by the same entity that operates computer 1301. Remote server 1303 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1303.

PUBLIC CLOUD 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1305 is performed by the computer hardware and/or software of cloud orchestration module 1331. The computing resources provided by public cloud 1305 are typically implemented by virtual computing environments that run on various computers making up the computers of host physical machine set 1332, which is the universe of physical computers in and/or available to public cloud 1305. The virtual computing environments (VCEs) typically take the form of virtual machines from virtual machine set 1333 and/or containers from container set 1333. It is understood that these VCEs may be stored as images and may be transferred among and between the various physical machine hosts, either as images or after instantiation of the VCE. Cloud orchestration module 1331 manages the transfer and storage of images, deploys new instantiations of VCEs and manages active instantiations of VCE deployments. Gateway 1330 is the collection of computer software, hardware, and firmware that allows public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes at least one of the computer executable components that:
generalizes entanglement forging of an electronic structure for quantum operations, wherein generalized entanglement forging (GEF) comprises:
initializing a calculation with a set of classical reference states, wherein the set of classical reference states are non-orthogonal Slater determinants;
correlating, on a quantum system, the set of classical reference states using a Jastrow ansatz, wherein the Jastrow ansatz is initialized from a classical electronic structure calculation; and
minimizing an energy function over a set of variational parameters of a wavefunction that represents the electronic structure.

2. The system of claim 1, wherein initializing the calculation with the set of classical reference states comprises:
replacing bitstrings with the non-orthogonal Slater determinants to represent quantum states of the electronic structure.

3. The system of claim 1, wherein at least one of the computer executable components further:
decomposes a Hamiltonian that represents the electronic structure using a low-rank decomposition; and
partitions the Hamiltonian into subsystems.

4. The system of claim 3, wherein partitioning the Hamiltonian into subsystems comprises:
partitioning the Hamiltonian into operators acting on halves of the electronic structure, wherein the operators are measured over a GEF quantum circuit.

5. The system of claim 2, wherein at least one of the computer executable components further:
prepares diagonal states and superposition states of the non-orthogonal Slater determinants with a quantum circuit to evaluate the energy function.

6. The system of claim 4, wherein decomposing the Hamiltonian comprises:
diagonalizing and partitioning terms of the Hamiltonian to construct the subsystems of the electronic structure;
obtaining measurements of qubits that represent quantum states of the subsystems over the GEF quantum circuit; and
combining the measurements of the subsystems to determine an energy of the electronic structure.

7. The system of claim 1, wherein at least one of the computer executable components further:
removes terms that correlate opposite-spin species to make the Jastrow ansatz of local unitary cluster type, wherein the Jastrow ansatz is a product of terms, and wherein each of the terms act on a half of the electronic structure.

8. A computer-implemented method, comprising:
generalizing, by a system operatively coupled to a processor, entanglement forging of an electronic structure for quantum operations, wherein generalized entanglement forging (GEF) comprises;
initializing a calculation with a set of classical reference states, wherein the set of classical reference states are non-orthogonal Slater determinants;
correlating, on a quantum system, the set of classical reference states using a Jastrow ansatz, wherein the Jastrow ansatz is initialized from a classical electronic structure calculation; and
minimizing an energy function over a set of variational parameters of a wavefunction that represents the electronic structure.

9. The computer-implemented method of claim 8, wherein initializing the calculation with the set of classical reference states comprises:
replacing bitstrings with the non-orthogonal Slater determinants to represent quantum states of the electronic structure.

10. The computer-implemented method of claim 8, further comprising:
decomposing, by the system, a Hamiltonian that represents the electronic structure using a low-rank decomposition; and
partitioning, by the system, the Hamiltonian into subsystems.

11. The computer-implemented method of claim 10, wherein partitioning the Hamiltonian into subsystems comprises:
partitioning the Hamiltonian into operators acting on halves of the electronic structure, wherein the operators are measured over a GEF quantum circuit.

12. The computer-implemented method of claim 9, further comprising:
preparing, by the system, diagonal states and superposition states of the non-orthogonal Slater determinants with a quantum circuit to evaluate the energy function.

13. The computer-implemented method of claim 11, wherein decomposing the Hamiltonian comprises:
diagonalizing and partitioning terms of the Hamiltonian to construct the subsystems of the electronic structure;
obtaining measurements of qubits that represent quantum states of the subsystems over the GEF quantum circuit; and
combining the measurements of the subsystems to determine an energy of the electronic structure.

14. The computer-implemented method of claim 11, further comprising:
removing, by the system, terms that correlate opposite-spin species to make the Jastrow ansatz of local unitary cluster type, wherein the Jastrow ansatz is a product of terms, and wherein each of the terms act on a half of the electronic structure.

15. A computer program product for generalizing entanglement forging (EF), the computer program product comprising a computer readable storage medium having program instructions embodied therewith, the program instructions executable by a processor to cause the processor to:
generalize, by the processor, entanglement forging of an electronic structure for quantum operations, wherein generalized entanglement forging (GEF) comprises:
initializing a calculation with a set of classical reference states, wherein the set of classical reference states are non-orthogonal Slater determinants;
correlating, on a quantum system, the set of classical reference states using a Jastrow ansatz, wherein the Jastrow ansatz is initialized from a classical electronic structure calculation; and
minimizing an energy function over a set of variational parameters of a wavefunction that represents the electronic structure.

16. The computer program product of claim 15, wherein initializing the calculation with the set of classical reference states comprises:
replacing bitstrings with the non-orthogonal Slater determinants to represent quantum states of the electronic structure.

17. The computer program product of claim 15, wherein the program instructions executable by the processor further causes the processor to:
decompose a Hamiltonian that represents the electronic structure using a low-rank decomposition; and
partition the Hamiltonian into subsystems.

18. The computer program product of claim 17, wherein partitioning the Hamiltonian into subsystems comprises:
partitioning the Hamiltonian into operators acting on halves of the electronic structure, wherein the operators are measured over a GEF quantum circuit.

19. The computer program product of claim 16, wherein the program instructions executable by the processor further causes the processor to:
prepare diagonal states and superposition states of the non-orthogonal Slater determinants with a quantum circuit to evaluate the energy function.

20. The computer program product of claim 18, wherein the program instructions executable by the processor further causes the processor to:
remove terms that correlate opposite-spin species to make the Jastrow ansatz of local unitary cluster type, wherein the Jastrow ansatz is a product of terms, and wherein each of the terms act on a half of the electronic structure.
